(19) United States
(12) Patent Application Publication
(10) Pub. No.: US 2020/0167737 A1
(43) Pub. Date: May 28, 2020

(54) SERVER DEVICE AND METHOD

(71) Applicant: TOSHIBA TEC KABUSHIKI KAISHA, Tokyo (JP)

(72) Inventor: Takeshi SHIMAZAKI, Sunto Shizuoka (JP)

(21) Appl. No.: 16/656,792

(22) Filed: Oct. 18, 2019

(30) Foreign Application Priority Data
Nov. 27, 2018 (JP) 2018-220966

(51) Int. Cl. G06Q 10/00; G06Q 20/20; G06F 11/34

(52) U.S. Cl. CPC G06Q 10/20; G06F 11/3419; G06Q 20/202

(57) ABSTRACT

According to one embodiment, a server device includes a communication interface and a processor configured to receive, through the communication interface, operation data from a plurality of information processing devices at a first location, calculate operating states of the plurality of information processing devices for a plurality of time periods based on the received operation data, and output the calculated operating states for the information processing devices by the time periods.

### CROSS-REFERENCE TO RELATED APPLICATION

This application is based upon and claims the benefit of priority from Japanese Patent Application No. 2018-220966, filed in Nov. 27, 2018, the entire contents of which are incorporated herein by reference.

### FIELD

Embodiments described therein relate generally to a server device and a method.

### BACKGROUND

In the related art, sales terminal maintenance systems are known in which a maintenance center is located at a point distant from retail stores to perform centralized management of each of the point of sales (POS) terminals running in the distant retail stores.

A prior art reference, JP-A-2002-197212, discloses a technology for automatically selecting a day on which a maintenance worker will visit a store to perform maintenance operations. The day is selected by acquiring a store's business schedule, operating hours, a store manager's availability, or the like and comparing the business schedule with a schedule of the maintenance worker.

However, when maintenance work is scheduled in this manner, the selected time may unintentionally overlap with a busy time of the store and the maintenance worker may not be able to complete the scheduled maintenance work as a result.

### DESCRIPTION OF THE DRAWINGS

FIG. 1 is a schematic diagram illustrating a configuration of a POS terminal maintenance system according to an embodiment.

FIG. 2 is a block diagram illustrating a hardware configuration of a POS maintenance computer.

FIG. 3 is a functional block diagram of a control unit of a POS maintenance computer.

FIG. 4 is a flowchart of a maintenance period selection process performed by a control unit of a POS maintenance computer.

FIG. 5 is a diagram illustrating an example of operating periods of POS terminals of a store by days of the week and times of day.

### DETAILED DESCRIPTION

Embodiments provide a server device and a method of operating the server device for scheduling maintenance workdays to avoid expected busy times.

In general, according to one embodiment, a server device includes a communication interface and a processor configured to receive, through the communication interface, operation data from a plurality of information processing devices at a first location, calculate operating states of the plurality of information processing devices at the first location for a plurality of time periods based on the received operation data, and generate an output including the calculated operating states by the time periods.

Hereinafter, examples embodiments of a server device and an operation method of a server device will be described with reference to the following appended drawings.

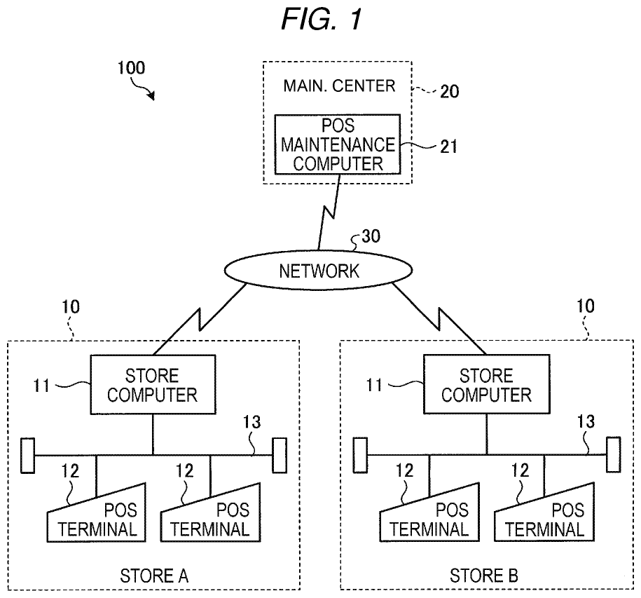

FIG. 1 is a schematic diagram illustrating a configuration of a POS terminal maintenance system 100 according to an embodiment. As illustrated in FIG. 1, the POS terminal maintenance system 100 comprises a store computer 11 in a POS system 10 for each store (e.g., store A & store B) and a POS maintenance computer 21 at a maintenance center 20 installed at a location away from each store. The store computers 11 of each POS system 10 are connected by a network 30, such as the Internet, to the POS maintenance computer 21 to be able to communicate each other.

POS terminals 12 in each store are all connected to the store computer 11 of the store via a local area network (LAN) 13. A POS terminal 12 is one example of an information processing device.

The POS terminal 12 includes a scanner, a keyboard, an operator display, a customer displayer, a printer that prints receipts and reports, and a hard disk drive (HDD) device. The POS terminal 12 performs the processing associated with sales transactions of items/commodities using commodity codes input by an operator (cashier) of the terminal. The POS terminal 12 performs a sales transaction processing as a predetermined process based on hardware and/or software. Here, sales transaction processing refers sales registration processing and settlement (payment) processing in combination.

The sales registration processing refers to a process of optically reading codes, such as barcodes, attached to items being sold commodities using a scanner, inputting the commodity codes, displaying commodity names, prices, or other commodity information for the commodities as read from the store computer 11 based on the input commodity codes, and storing the commodity information in a buffer or local memory.

The settlement processing refers to a process of displaying a sum of money related to transaction based on the accumulated commodity information stored in the buffer in the sales registration processing and calculating and displaying change due based on an amount of money tendered a customer, a process of instructing a change making machine to give the change due, and a process of issuing a receipt on which the commodity information or settlement information (e.g., the sales transaction total, the amount tendered, and the change due, or the like) is printed.

The POS terminal 12 transmits data generated in the operation of the POS terminal 12 to the POS maintenance computer 21 via the store computer 11. Here, the data is various kinds of information included in sales transaction data generated in a transaction processes during a fixed time period or the like. The transmitted data may also include maintenance inspection information generated in a maintenance inspection of the POS terminal 12.

The store computer 11 has a commodity master file (database) in which commodity information, such as a commodity code, a commodity name, and a unit price of each commodity sold in the store are stored. The store computer 11 responds to a commodity data inquiry from a POS terminal 12 or collects sales data generated in a transaction process for registering each POS terminal 12 for total sales. The store computer 11 provides various sales analysis reports based on accumulated transaction information.

The POS maintenance computer 21 is an example of a server device. The POS maintenance computer 21 has a function of collecting operating state information of the POS terminals 12 installed in each store by time periods. The operating state information is based on operation data collected from the POS terminals 12 and the store computer 11 for each store via the network 30. The POS maintenance computer 21 has a function of outputting the operating states of the POS terminals 12 at a store by time period.

Next, a hardware configuration of the POS maintenance computer 21 will be described.

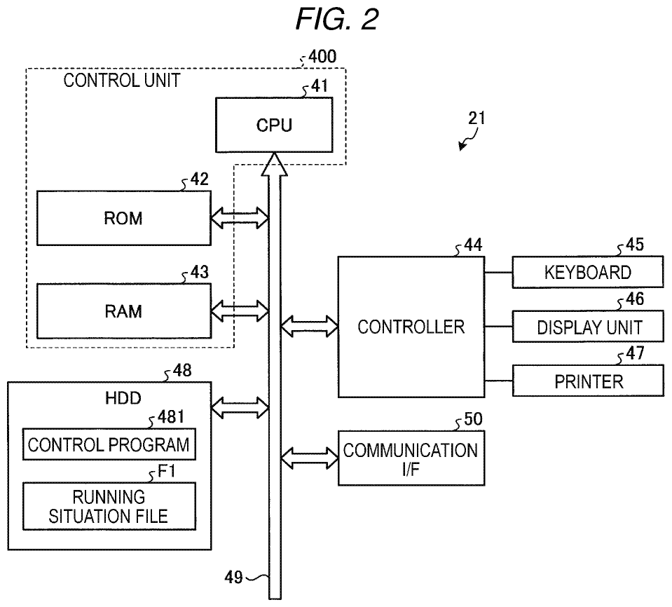

FIG. 2 is a block diagram illustrating a hardware configuration of the POS maintenance computer 21. The POS maintenance computer 21 includes a control unit 400 that has a computer configuration including a central processing unit (CPU) 41, a read-only memory (ROM) 42, a random access memory (RAM) 43.

The control unit 400 is connected to a communication interface (I/F) 50 via a bus 49. The POS maintenance computer 21 performs online communication with the plurality of store computers 11 via the communication I/F 50 and the network 30 (see FIG. 1). A keyboard 45, a display unit 46, and a printer 47 are connected to the control unit 400 via the bus 49 and a controller 44.

A hard disk drive (HDD) 48 is connected to the control unit 400 via the bus 49. The HDD 48 stores various control programs 481 for causing the control unit 400 to operate as instructed.

The HDD 48 stores an operating state file F1 for accumulating collection results of operating states by POS terminal ID numbers specific each of the POS terminals 12 installed in each store. The collection results are accumulated by time period (e.g., day of week and time of day) for each of the POS terminals 12 or in aggregation by store site or the like.

The control unit 400 collects and updates the operating states by time periods for the POS terminals 12 installed in each store based on the operation data collected from the POS terminals 12 and the store computer 11 via the network 30 and this information is stored in the operating state file F1 in each store.

A control program 481 that is executed in the POS maintenance computer 21 according to the embodiment may be a file with an installable format or an executable format and may be recorded on a nonvolatile computer-readable recording medium for supply. The recording medium in this context can be a CD-ROM, a flexible disc (FD), a CD-R, a digital versatile disk (DVD), or the like.

Further, the control program 481 that is executed by the POS maintenance computer 21 may be stored on a computer connected to a network, such as the Internet, to be downloaded via the network for supply. In some instances, the control program 481 that is executed by the POS maintenance computer 21 may be supplied via or distributed across a network, such as the Internet.

Next, a maintenance period selection process performed by the control unit 400 of the POS maintenance computer 21 according to an embodiment in accordance with the control program 481 will be described.

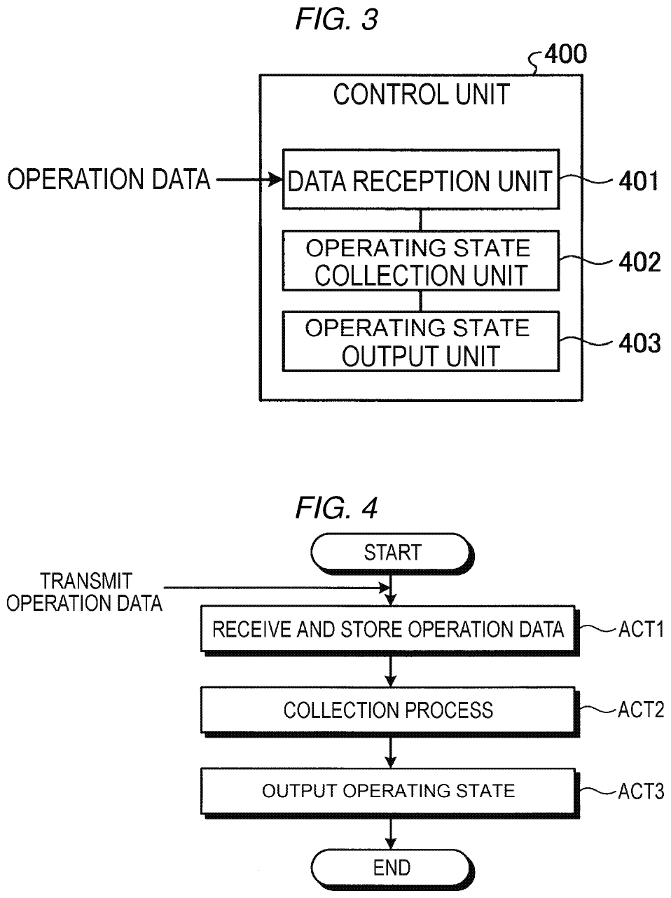

FIG. 3 is a functional block diagram illustrating a functional configuration of the control unit 400 of the POS maintenance computer 21. The control unit 400 functions as a data reception unit 401 that receives data in accordance with the control program 481 stored in the HDD 48 or the like, an operating state collection unit 402 (also referred to as running state collection unit 402) that collects operating states, and an operating state output unit 403 that outputs the operating states.

The data reception unit 401 receives an input of operation data related to operation(s) of the POS terminals 12. The operation data may be or include various kinds of information and included in sales data generated in a transaction process and/or transmitted at a fixed time. Specifically, the collected operation data can be or include sales information indicating a sales amount or the number of customers per POS terminal 12. The operation data can be or include processing time information indicating a time at which the POS terminal 12 performs a sales transaction process. The operation data can be or include login time information indicating a login time at which the POS terminal 12 performs a login transaction process. The operation data can be or include power-on time information indicating the times at which the POS terminal 12 was powered on for performing some transaction process. The operation data may also include a history of maintenance inspection work performed on the POS terminal 12.

The operating state collection unit 402 collects operating states by time periods for the POS terminal(s) 12 based on the operation data. The operating state collection unit 402 collects operating states of the POS terminal 12 by time periods based on the process time information. The operating state collection unit 402 collects operating states of the POS terminal 12 by time periods based on the login time information. The operating state collection unit 402 collects operating states for the POS terminal (s) 12 by time period based on power-on time information.

The operating state output unit 403 outputs the operating states by the time periods for the POS terminals 12. More specifically, the operating state output unit 403 displays the operating states by time periods for the POS terminal(s) 12 on the display unit 46. The operating state output unit 403 causes the printer 47 to print the operating state by time period reports for the POS terminal(s) 12.

FIG. 4 is a flowchart illustrating a flow of the maintenance period selection process performed by the control unit 400 of the POS maintenance computer 21.

As illustrated in FIG. 4, each POS terminal 12 installed in each store transmits the operation data to the POS maintenance computer 21 via the store computer 11 at a predetermined timing or as deemed necessary. As described above, the operation data may be various kinds of information related to operation of a POS terminal 12.

As noted, the operation data can be or include sales information indicating a sales amount or the number of customers per POS terminal 12, processing time information indicating a time at which the POS terminal 12 performs a sales transaction process, login time information indicating a login time at which the POS terminal 12 performs a login transaction process, power-on time information indicating a time at which the POS terminal 12 was powered on for performing a transaction process, and/or a history indicating information of a previous maintenance inspection work performed on the POS terminal 12.

The control unit 400 (as the data reception unit 401) of the POS maintenance computer 21 receives the operation data transmitted from the POS terminal and stores the operation data in the RAM 43 or the like (ACT1). An input of the operation data to the data reception unit 401 is not necessarily limited to data transmission via the network 30. For example, an input of the operation data to the data reception unit 401 may be made via the keyboard 45 of the POS maintenance computer 21 in some instances.

The control unit 400 (more particularly, the operating state collection unit 402) of the POS maintenance computer 21 performs a collection process for information related to the setting of the maintenance inspection day by a maintenance worker (ACT2). Specifically, the control unit 400 (as the operating state collection unit 402) of the POS maintenance computer 21 performs a collection process related to the running/operation of each POS terminal 12 in a store based on the received operation data (for example, the sales transaction time information or the like) that has been transmitted from the POS terminals 12. In the collection process, operating states of the POS terminals 12 by time period (day of the week and time of day) in each store are collected and the operating state file F1 is updated.

The operating states of the POS terminals 12 by time periods in each store, for example, running rates (number of sales transactions per unit time periods) by day and time of the POS terminals 12 in each store, can be calculated based on the operation data, such as processing time information or the like. Then, the control unit 400 (more particularly, operating state collection unit 402) of the POS maintenance computer 21 derives time periods in which the running rates are less than predetermined thresholds.

In ACT3, control unit 400 (more particularly, the operating state output unit 403) of the POS maintenance computer 21 outputs the operating states of the POS terminals 12 collected in the collection process of ACT2 (“OUTPUT OPERATING STATE”) for each store. The operating state output unit 403 displays the operating states by the time periods for the various POS terminals 12 on the display unit 46 or causes the printer 47 to print out a report on the operating states by the time periods. The operating states may also be shown with graphs or charts.

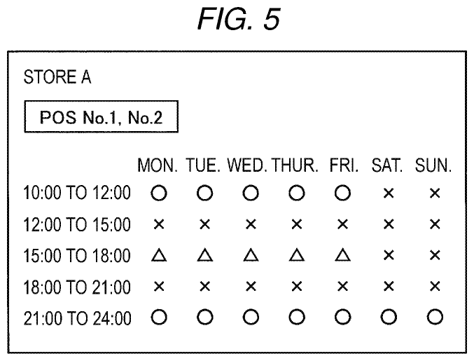

FIG. 5 is a diagram illustrating an example of operating states by time periods, more particularly by day of the week and time of day for two POS terminals 12 (No.1 & No.2). In FIG. 5, the operating states of the two POS terminals 12 in store A for operating periods in which it is expected that customers can be appropriately handled using a single POS terminal 12 are indicated by “◯”, periods in which it is expected that customers cannot be appropriately handled without using both POS terminals 12 are indicated by “×”, and periods in which it is possible that customers cannot be handled using a single POS terminal 12 depending on circumstances are indicated by “Δ”.

The maintenance worker checks days of week and periods of time in which maintenance inspection of the POS terminals 12 in the store is possible, and can select a time (day and time period) based on the expected operating states of the POS terminals 12 in each store as generated by the POS maintenance computer 21. Specifically, the maintenance worker identifies days of week and periods of time in which running rates of the POS terminals 12 and/or the total number of POS terminals in use at the store are low such that either the amount of sales or the number of customers per POS terminal 12 will be small as possible times to conduct maintenance inspections. In the example illustrated in FIG. 5, the periods of time in which customers can be handled using just one POS terminal 12, as indicated by “◯”, are identified to be times at which maintenance inspection is possible.

The maintenance worker contacts a person in charge of the store to inform the person of these times being as candidates for times for a maintenance inspection. In some cases, when attempting to schedule an appointment, the maintenance worker may refer to particular days of the week as possible rather than specific times within the day, since appointment by days of week rather than specific times be more easily established.

The maintenance worker then visits the store on the day of week for which the appointment is established and performs maintenance inspection work. When maintenance inspection work is performed on a particular POS terminal 12, a history file or the like indicating that maintenance inspection work has been performed on the POS terminal 12 can be transmitted to the POS maintenance computer 21 via the store computer 11. Thus, the history file can be referred to for the next maintenance inspection work.

In this way, the server device according to the embodiment calculates the running rates by time periods for the POS terminals 12 in the store so that the running rates can be referred to in scheduling appointments for maintenance work. Thus, by checking in advance for times at which running rates are low, it is possible to make suggest appointment times/days for the maintenance inspection work that are likely to avoid busy times of the stores. Thus, the appointment can be more easily established.

In an example embodiment, as described above, the POS terminal 12 is an example of an information processing device, but the present disclosure is not limited thereto and can be applied to various information processing devices such as a mobile terminals, handheld devices, and printers.

While certain embodiments have been described these embodiments have been presented by way of example only, and are not intended to limit the scope of the present disclosure. Indeed, the novel embodiments described herein may be embodied in a variety of other forms; furthermore, various omissions, substitutions and changes in the form of the embodiments described herein may be made without departing from the spirit of the present disclosure. The accompanying claims and their equivalents are intended to cover such forms or modifications as would fall within the scope and spirit of the present disclosure.

What is claimed is:

1. A server device, comprising:
a communication interface; and
a processor configured to:
receive, through the communication interface, operation data from a plurality of information processing devices at a first location;
calculate operating states of the plurality of information processing devices at the first location for a plurality of time periods based on the received operation data; and
generate an output including the calculated operating states by the time periods.

2. The server device according to claim 1, wherein
the operation data includes a transaction processing rate for each information processing device in the plurality of information processing devices, and
the operating states are calculated based on the transaction processing rate for each information processing device in the plurality of information processing devices.

3. The server device according to claim 1, wherein
the operation data includes login time information indicating login transaction times for each information processing device in the plurality of information processing devices, and
the operating states are calculated based on the login transaction times for each information processing device in the plurality of information processing devices.

4. The server device according to claim 1, wherein
the operation data includes power-on time information indicating when each information processing device in the plurality of information processing devices was in a power-on state, and
the operating states are calculated based on the power-on time information for each information processing device in the plurality of information processing devices.

5. The server device according to claim 1, wherein the operation data includes a maintenance inspection work history for at least one information processing device in the plurality of information processing devices.

6. The server device according to claim 1, wherein the information processing devices are point-of-sale terminals.

7. The server device according to claim 1, wherein the first location is a retail store.

8. The server device according to claim 1, wherein the output is a summary table listing calculated operating states by days of the week for each of the time periods.

9. The server device according to claim 1, wherein the processor is further configured to suggest at least one time period for a scheduled maintenance appointment for the first location based on the calculated operating states for the plurality of information processing devices.

10. A method for scheduling maintenance visits, the method comprising:
receiving operation data from a plurality of information processing devices at a first location;
calculating operating states of the plurality of information processing devices at the first location for a plurality of time periods based on the received operation data; and
generating an output including the calculated operating states by the time periods.

11. The method according to claim 10, wherein
the operation data includes a transaction processing rate for each information processing device in the plurality of information processing devices, and
the operating states are calculated based on the transaction processing rate for each information processing device in the plurality of information processing devices.

12. The method according to claim 10, wherein
the operation data includes login time information indicating login transaction times for each information processing device in the plurality of information processing devices, and
the operating states are calculated based on the login transaction times for each information processing device in the plurality of information processing devices.

13. The method according to claim 10, wherein
the operation data includes power-on time information indicating when each information processing device in the plurality of information processing devices was in a power-on state, and
the operating states are calculated based on the power-on time information for each information processing device in the plurality of information processing devices.

14. The method according to claim 10, wherein the operation data includes a maintenance inspection work history for at least one information processing device in the plurality of information processing devices.

15. The method according to claim 10, wherein the information processing devices are point-of-sale terminals.

16. The method according to claim 10, wherein the first location is a retail store.

17. The method according to claim 10, wherein the output is a summary table listing calculated operating states by days of the week for each of the time periods.

18. The method according to claim 10, further comprising:
suggesting at least one time period for a scheduled maintenance appointment for the first location based on the calculated operating states for the plurality of information processing devices.

19. A non-transitory computer-readable medium storing program instructions that when executed by a processor cause the processor to:
receive operation data from a plurality of information processing devices at a first location;
calculate operating states of the plurality of information processing devices at the first location for a plurality of time periods based on the received operation data; and
generate an output including the calculated operating states by the time periods.

20. The non-transitory computer-readable medium according to claim 19, wherein the program instructions further cause the processor to:
suggest at least one time period for a scheduled maintenance appointment for the first location based on the calculated operating states for the plurality of information processing devices.
